(19) United States
(12) Patent Application Publication
(10) Pub. No.: US 2005/0262547 A1
(43) Pub. Date: Nov. 24, 2005

(54) Method and apparatus for providing a platform-independent audio/video service

(76) Inventor: Yves Langlais, Montreal (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/944,507

(22) Filed: Sep. 20, 2004

Related U.S. Application Data
(63) Continuation-in-part of application No. 10/849,117, filed on May 20, 2004.

(51) Int. Cl. H04N 7/16; H04N 7/173

(52) U.S. Cl. 725/135; 725/112; 725/113

(57) ABSTRACT

A method and apparatus for providing a platform-independent audio/video service to a plurality of users over a packet-switched network. Audio/video signals are sent to a remote user where they are read using a sequence of processing operations that are independent of the remote user's processing unit. In other embodiments, the processing operations are comprised in a web browser or in hardware equipment which have as there main function the provision of the audio/video service. Also, other embodiments include an audio/video mailbox service that uses the foregoing audio/video service.

### CROSS-REFERENCE TO RELATED APPLICATIONS

This application claims priority under 35 USC § 120 and is a continuation-in-part of U.S. Ser. No. 10/849,117 filed May 20, 2004, the specification of which is hereby incorporated by reference.

### TECHNICAL FIELD

This invention relates to the field of data communications. More precisely, this invention pertains to a method and apparatus for providing a platform-independent audio/video service to a remote user.

### BACKGROUND OF THE INVENTION

In today's world, telecommunications between individuals are of ever increasing importance. Audio communication is achieved, for instance, using various solutions, the most popular of which is the telephone.

With the development of Wide Area, packet-switched, Networks, such as the Internet, various new embodiments of the telephone are now available, such as IP telephones for instance. These new embodiments take advantage of this new type of switching.

Surprisingly it is still not easy to provide a combined audio/video service to a plurality of users similar to what is offered by existing voice networks. In fact, some hardware video-conferencing companies have developed dedicated audio/video hardware solutions adapted to provide the audio/video service. Unfortunately, such hardware solutions are usually quite expensive and not very flexible. Furthermore, such hardware solutions require dedicated phone lines as well as a specific setup.

With the increase in processing power of current processing units, software solutions have now been developed to provide the audio/video service to clients over the Internet for instance.

However, such software solutions require that platform specific client software applications be installed on each user's processing unit. Installation of the various client applications is often not easy for a home user. The skilled addressee will also appreciate that, in the case of corporations, such installations are not desirable either since they increase the workload of system administrators.

Furthermore, the fact that such varied client applications are usually limited to very specific operating systems is part of the reason for which they are not yet widely adopted.

There is therefore a need for a method and apparatus that will overcome the above-identified drawbacks.

### SUMMARY OF THE INVENTION

It is an object of the invention to provide a platform-independent audio/video service to a plurality of users using a packet-switched network. Alternatively, an email service may be combined with the audio/video service.

According to an aspect of the invention, there is provided a method and apparatus for providing a platform-independent audio/video service to a plurality of users over a packet-switched network. Audio/video signals are sent to a remote user where they are read using a sequence of processing operations that are independent of the remote user's processing unit. In other embodiments, the processing operations are comprised in a web browser or in hardware equipment which have as there main function the provision of the audio/video service. Also, other embodiments include an audio/video mailbox service that uses the foregoing audio/video service.

According to another aspect of the invention, there is provided a method for providing a platform-independent audio/video service to a plurality of users. The method comprises providing an audio/video signal to be transmitted to a user, encapsulating the audio/video signal into a data packet, the data packet to be read using a sequence of processing operations suitable for delivering an audio/video signal, delivering the encapsulated audio/video signal to the user and wherein the sequence of processing operations is independent of a given type of processing unit and thereby enables the provision of a platform-independent audio/video service.

According to another aspect of the invention, there is provided a method for providing a platform-independent audio/video service to a plurality of users. The method comprises providing an audio/video signal to be transmitted to a user, encapsulating the audio/video signal into a data packet, the data packet to be read by a Web browser comprising a module for delivering a video signal, delivering the encapsulated audio/video signal to the user via the Web browser and wherein the module is comprised in the Web browser by default.

According to yet another embodiment, the present invention provides a method for providing a platform-independent audio/video service to a user using a processing unit connected to a network. The method comprises said user performing a registration check for the service (e.g., through a web site) and providing an audio/video signal from a source. The source may include, for example, another user's environment, the environment of more than one user, and/or surveillance cameras. The method further comprises producing an audio/video output from the audio/video signal using a sequence of processing operations that is independent of operating systems running said user's processing unit and displaying the audio/video output to said user.

According to still another embodiment, the present invention provides a method for providing a platform-independent audio/video service to a user using a processing unit connected to a network. The method comprises: the user accessing a web site to perform a registration check for the service; providing an audio/video signal from an audio/video source; producing an audio/video output from the audio/video signal using a web browser comprising a module for delivering a video signal; and displaying the audio/video output to the user through the web browser.

### BRIEF DESCRIPTION OF THE DRAWINGS

Further features and advantages of the present invention will become apparent from the following detailed description, taken in combination with the appended drawings, in which:

FIG. 1 is a block diagram which shows a system for providing a platform-independent audio/video service; the system comprises a first processing unit, a remote processing unit and an audio/video server unit according to an embodiment of the invention;

FIG. 2 is a flowchart which shows how, according to an embodiment of the invention, a user may communicate with a remote user using the platform-independent audio/video server;

FIG. 3 is a flowchart which shows how, according to an embodiment of the invention, a user establishes a connection with an audio/video server;

FIG. 4 is a flowchart which shows how, according to an embodiment of the invention, an account is created with the audio/video server;

FIG. 5 is a flowchart which shows how, according to an embodiment of the invention, a communication is performed between the user and the remote user via a web interface;

FIG. 6 is a flowchart which shows how, according to an embodiment of the invention, an attempt to communicate with a remote user is conducted;

FIG. 7 is a screenshot which shows an embodiment of a user interface which is provided to a user;

FIG. 8 is a screenshot which shows another example of the user interface displayed on one of the processing unit;

FIG. 9 is a flowchart which shows how, according to an embodiment of the invention, an acquired audio/video signal is compressed;

FIG. 10 is a flowchart which shows how, according to an embodiment of the invention, a received compressed audio/video signal is decompressed;

It will be noted that throughout the appended drawings, like features are identified by like reference numerals.

### DETAILED DESCRIPTION OF A PREFERRED EMBODIMENT

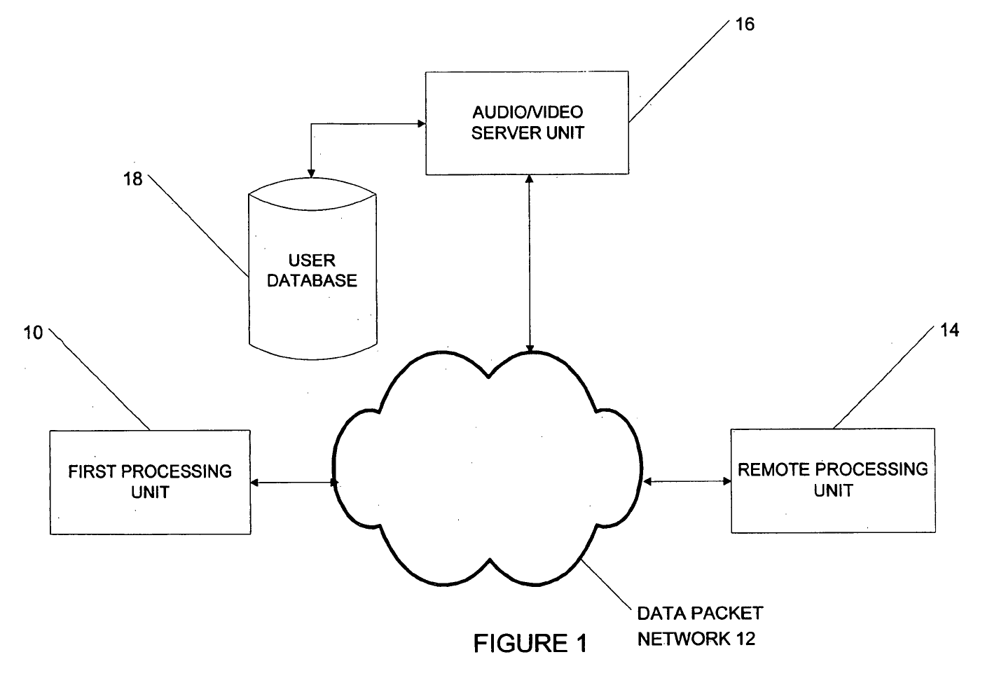

Now referring to FIG. 1, there is shown a system for providing a platform-independent audio/video service. The system comprises a first processing unit 10, a data packet network 12, a remote processing unit 14, an audio/video server unit 16 and a user database 18.

The first processing unit 10 may be any one of a computer, a portable, a personal digital assistant (PDA), a dedicated processing unit, a mobile phone or the like. The first processing unit 10 comprises a network interface for communicating with the data packet network 12. Thus, the first processing unit 10 is capable of sharing data packets with the data packet network 12. The first processing unit 10 further comprises preferably an audio/video acquisition device (not shown) and an audio output device (not shown).

In a preferred embodiment, the first processing unit 10 has components adapted with various characteristics such as available bandwidth for instance.

At this point it should be understood that the first processing unit 10 comprises, in a preferred embodiment, an application for communicating through the data packet network 12. In a preferred embodiment, the application for communicating through the data packet network 12 is a Web browser.

In fact it should be appreciated that more generally a sequence of processing operations suitable for delivering or, more generally, producing an audio/video signal is provided. In a preferred embodiment, the sequence of processing operations is compiled and is comprised in a software application which is a Web browser. The software comprising the compiled processing operations may be a standalone application which may be run independently of a particular operating system which is of great advantage. In a preferred embodiment, the standalone application may be the Flash player application/plug-in from Macromedia Inc.

In yet another embodiment, the sequence of processing operations suitable for producing an audio video signal may bypass the Web browser and the Operating System level and may be used directly by the processing unit. Furthermore, the sequence of processing operations suitable for producing an audio video signal may be downloaded from said audio/video server unit to the processing units 10, 14 or from any other source.

Preferably, the sequence of processing operations suitable for producing an audio video signal includes or is supplemented by a compression and decompression algorithm that will be discussed in detail hereinbelow.

Alternatively, the sequence of processing operations may be implemented in hardware in the first processing unit 10. The skilled addressee will appreciate that such sequence of processing operations is independent of a given type of processing unit and thereby enables the provision of a platform-independent audio/video service.

The data packet network 12 is any one of a Local Area Network (LAN), a Metropolitan Area Network (MAN), a Wide Area Network (WAN) or a combination thereof. In a preferred embodiment of the invention, the data packet network 12 is the Internet.

The remote processing unit 14 may be any one of a computer, a portable, a personal digital assistant (PDA), a dedicated processing unit, a mobile phone or the like. The remote processing unit 14 comprises a network interface for communicating with the data packet network 12. Thus, the remote processing unit 14 is capable of sharing data packets with the data packet network 12. The remote processing unit 14 further comprises preferably an audio/video acquisition device and an audio output device. In a preferred embodiment, the remote processing unit 14 has components adapted with various characteristics such as available bandwidth for instance. The remote processing unit may be a computer, a PDA device, a cell phone or any other device which may communicate with the data packet network 12.

At this point it should be understood that the remote processing unit 14 comprises a remote processing unit application for communicating through the data packet network 12.

The audio/video server unit 16 is a processing unit adapted for providing the platform-independent audio/video service to a plurality of users as explained below. In the exemplary embodiment disclosed in FIG. 1, the platform-independent audio/video service is provided between the first processing unit 10 and the remote processing unit 14 via the data packet networks 12.

In a preferred embodiment, the audio/video server unit 16 is adapted for performing load balancing. Furthermore, a suitable mirroring system is provided in the audio/video server unit 16. The audio/video server unit 16 is operatively connected to the user database 18.

The user database 18 comprises data concerning registered users. More precisely, the database 18 comprises a list of registered users. For each of the registered users, the database comprises a login and password, an indication of the status of the user such as online, communicating, offline, etc. The user database 18 further comprises, for each registered user, customized data, a list of contacts, etc. Depending on a subscription, the user database 18 may further comprise for a given user an answering machine message and eventually at least one message left for the given user by another user.

In a preferred embodiment, the user database 18 is implemented using a first database, a second database and a third database. More precisely, the first database comprises a list of blocked users and for each user, data such as a userID, profile, etc. The first database further comprises an n by n matrix where for each user it is possible to find out with which other users it is possible to communicate. It has been contemplated that such matrix is of great advantage for quickly accessing data in the case of a large number of users. The first database further comprises administration data. The second database comprises a list of pointers, each pointer pointing to the beginning of an audio/video/text message. The third database comprises the audio/video/text messages.

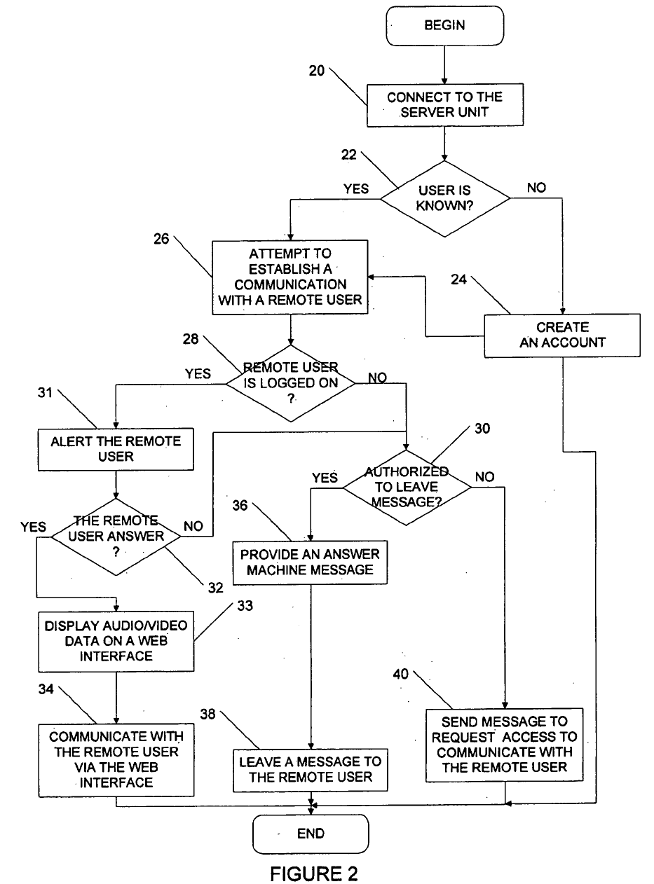

Now referring to FIG. 2, there is shown how a user of the first processing unit 10 may communicate with a remote user of the remote processing unit 14 via the data packet network 12 using the audio/video server 16. According to step 20, the user of the first processing unit 10 connects to the audio/video server unit 16.

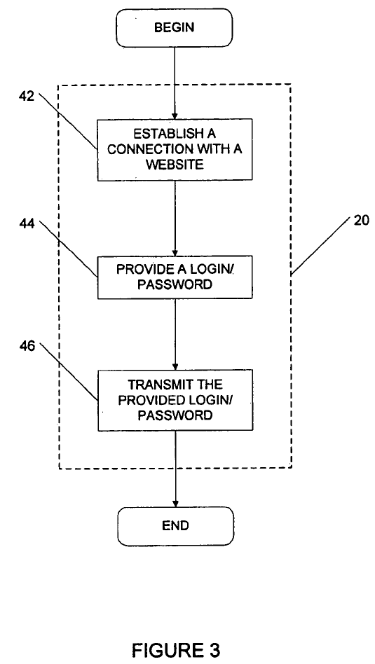

Now referring to FIG. 3, there is shown how the user of the first processing unit 10 connects to the audio/video server unit 16. According to step 42, a connection is established with a website. The web server, providing an access to the website, may be comprised in the audio/video server unit 16. Alternatively, the web server may be comprised at another location on the data packet network 12 and may redirect a request to the audio/video server unit.

According to step 44, a login and password is entered by the user on a form displayed on the browser of the first processing unit 10. The login and password is used to uniquely identify the user in the system.

According to step 46, the login and password are transmitted to the audio/video server unit 16 via the data packet network 12. It will be appreciated that preferably the login and password are transmitted to the audio/video server unit 16 using a secure connection such as secure socket layer (SSL).

Now referring back to FIG. 2 and according to step 22, a check is performed by the audio/video server unit 16 in order to find out if the combination of login and password is legitimate, i.e., if the user is known. A combination is legitimate if the combination of login and password already exists in the user database 18. Such a check is performed using the user database 18.

In the case where the combination of login and password is legitimate, a customized user interface is displayed on the browser of the first processing unit 10.

It will be appreciated that preferably various user interfaces may be provided to the user according to a subscription. For instance, a user may be capable of communicating with a plurality of users simultaneously in a given type of subscription. Also, it should be appreciated that advertising based on physical location of the user may be provided on the user interface.

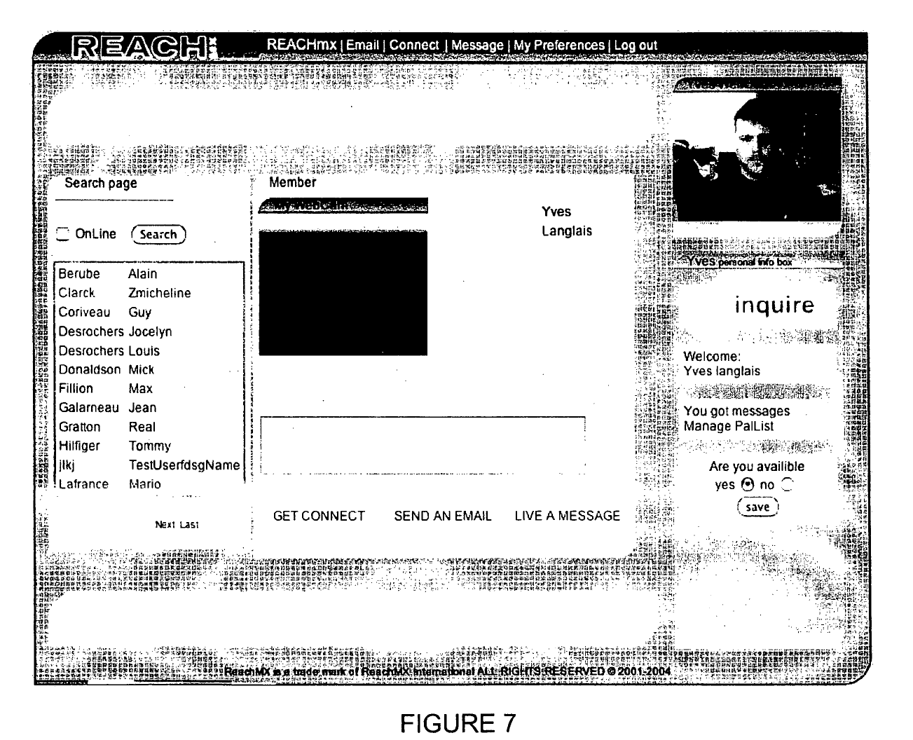

Now referring to FIG. 7, there is shown an embodiment of a user interface which is provided to the user. The user interface comprises a video screen displaying a live captured video of the user operating the first processing unit 10. The user interface further comprises a list of contacts and an indication of a status. In such a case, the user operating the first processing unit 10 has received messages.

Now referring back to FIG. 2 and according to step 26, an attempt to establish a communication with a remote user is performed.

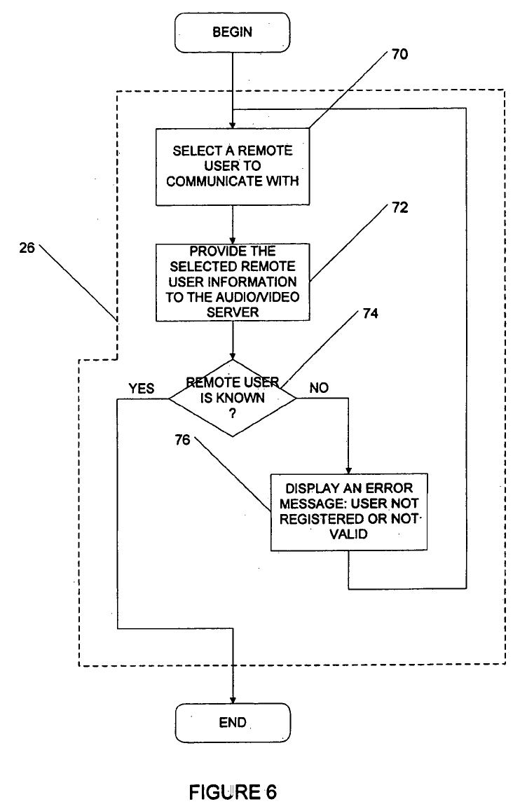

Now referring to FIG. 6, there is shown how the attempt to establish a communication with a remote user is performed. According to step 70, a remote user, using the remote processing unit 14 with which communication is requested, is selected by the user of the first processing unit 10 using via the user interface. As explained previously, a list of a plurality of remote users is provided through the user interface. It should also be appreciated by the skilled addressee that, through the user interface, a new remote user may be added or deleted from the list of the plurality of remote users displayed.

According to step 72, the selected remote user information is provided to the audio/video server unit 16 via the data packet network 12. A test is performed according to step 74 in order to find out if the selected remote user is known by the audio/video server unit 16. It will be appreciated that the selected remote user is known if information indicative of the selected remote user is comprised in the user database 18. The test to find out if the selected remote user is known by the audio/video server unit 16 is performed by the audio/video server unit 16 using the user database 18. In the case where the remote user is not known and according to step 76, a message indicating that the supplied information is not valid or that the user is not known is displayed on the user interface of the first processing unit 10.

It will be appreciated that in the embodiment where a list of a plurality of remote users is displayed on the user interface of the first processing unit 10, such test is not necessary.

In the case where the selected remote user is known and according to step 28 (returning to FIG. 2), a test is performed in order to find out if the selected remote user is logged on to the audio/video server unit 16 via the remote processing unit 14. The latter test is performed using the user database 18. In the case where the selected remote user is logged on the audio/video server unit 16 and according to step 31, an alert signal is provided to the selected remote user via the user interface of the remote processing unit 14.

The alert signal may be at least one of a visual signal, an audio signal, a video signal or the like. For instance, the visual signal may be a flashing light, the audio signal may be a beeping sound, and the video signal may be a video stream and/or a text message.

According to step 32, a test is performed in order to find out if the selected remote user reacts in response to the alert signal provided according to step 31. The test is performed using the user interface of the remote processing unit 14 and the audio/video server unit 16.

Upon reaction of the remote user on the user interface of the remote processing unit 14, a signal indicative of the reaction is provided to the audio/video server unit 16. In the case where the remote user does not react on the user interface of the remote processing unit 14 and according to step 30, a test is performed in order to find out if the user is authorized to leave a message audio/video message box assigned to the remote user. The test is performed by the server unit 16.

In the case where the remote user reacts on the user interface of the remote processing unit 14 and according to step 33, audio/video data is displayed on the user interface of the user and on the user interface of the remote user.

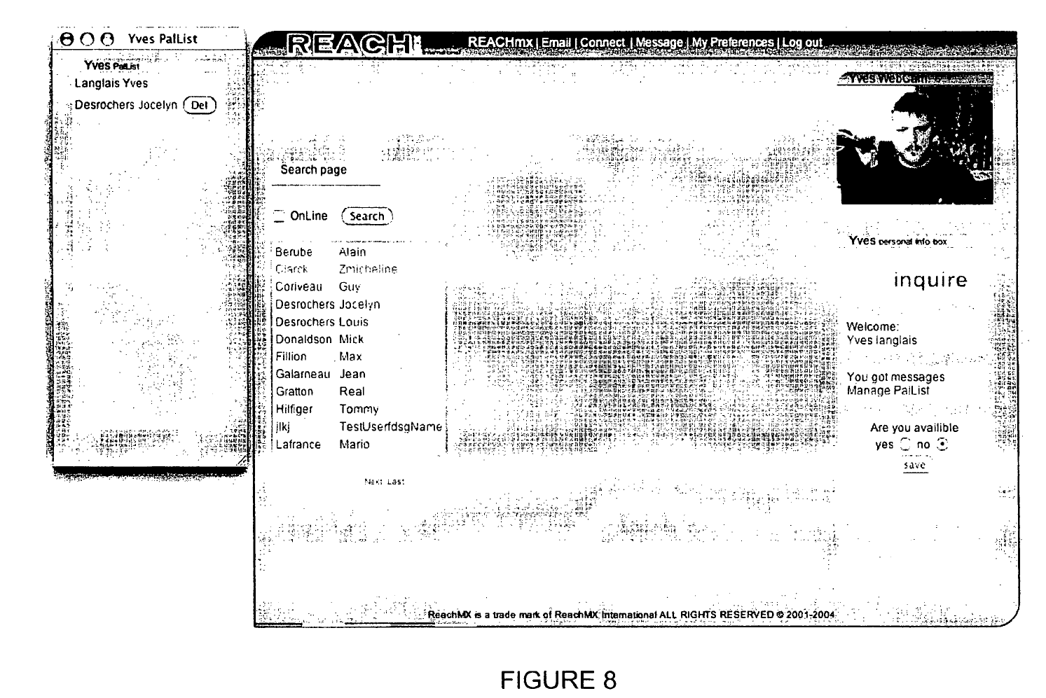

In a preferred embodiment, the data displayed on the user interface of the user and on the user interface of the remote user comprise a live video of the user and a live video of the remote user together with an audio signal indicative of a conversation between the user and the remote user. Alternatively, various other signals may be provided on each corresponding interfaces such as predefined objects or files. FIG. 8 shows an example of the user interface displayed on one of the processing unit 10 and the remote processing unit 14.

According to step 34, the user communicates with the remote user via a respective user interface displayed on a respective processing unit. In a preferred embodiment of the invention, suitable Internet ports such as 80 and 88 are used for communicating between the user and the remote user.

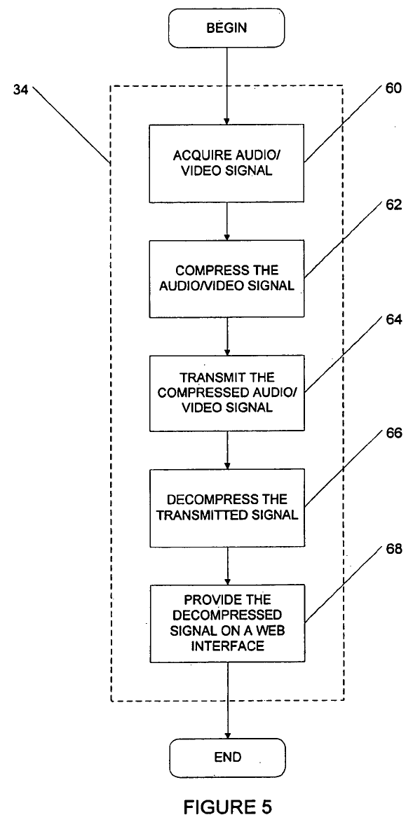

Now referring to FIG. 5, there is shown how the user communicates with the remote user. The skilled addressee will appreciate that a similar process takes places in the other direction, i.e., from the remote user to the user. According to step 60, an audio/video signal of the user is acquired on the first processing unit 10. According to step 62, the audio/video signal is compressed. In a preferred embodiment, the audio/video signal is compressed by the first processing unit 10 in accordance with a compression algorithm. In an alternative embodiment, the audio/video signal may be compressed by the audio/video server unit 16.

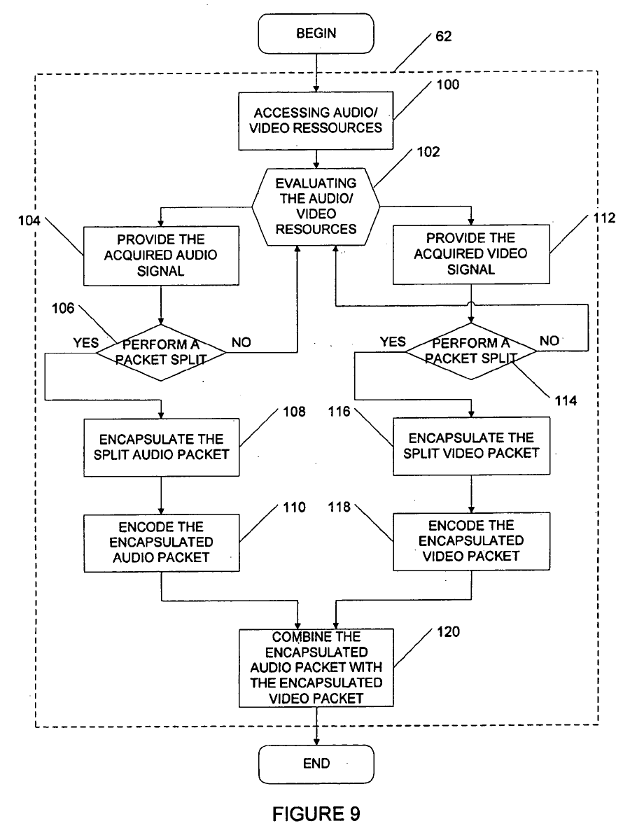

Now referring to FIG. 9, there is shown how the audio/video signal is compressed. According to step 100, audio/video resources are accessed. According to step 102, the accessed audio/video resources are evaluated. More precisely, local resources are evaluated to find a suitable quality of transmission of data. In fact, the skilled addressee will appreciate that a low level of available resources is not suitable for transmission of a high amount of data. Such evaluation of the audio/video resources is therefore desirable in order to optimize the use of the audio/video resources.

According to step 104, the acquired audio signal is provided. According to step 106, a test for performing a packet split of the acquired audio signal is performed. It will be appreciated the packet split of the acquired audio signal may be performed according to parameters such as connection speed, availability of a connection link, etc.

In the case where packet split cannot be performed, the audio/video resources are evaluated according to step 102. In the case where the packet split of the acquired audio signal is performed and according to step 108, the split audio packet is encapsulated. According to step 110, the encapsulated audio packet is then encoded. In a preferred embodiment, the encapsulated audio packet is encoded using the H263 algorithm.

According to step 112, the acquired video signal is provided. According to step 114, a test for performing a packet split of the acquired video signal is performed. It will be appreciated the packet split of the acquired video signal may be performed according to parameters such as connection speed, availability of a connection link, etc.

In the case where packet split cannot be performed, the audio/video resources are evaluated according to step 102. In the case where a packet split is performed and according to step 116, the split video packet is encapsulated. According to step 118, the encapsulated split video packet is encoded. In a preferred embodiment, the encapsulated split video packet is encoded using the H263 algorithm and a Sorenson-like algorithm.

According to step 120, the encoded and encapsulated audio packet and the encoded and encapsulated video packet are combined. While it will be appreciated that the compression algorithm may be implemented in software or in hardware, the compression algorithm is preferably implemented in software.

Referring back to FIG. 5 and according to step 64, the compressed video signal is transmitted to the remote processing unit 14 using the data packet network 12.

It will be appreciated by the skilled addressee that various routing schemes departing from the scope of the invention may be used in order to deliver the compressed video signal to the remote processing unit 14. According to step 66, the transmitted signal is decompressed. The transmitted signal is preferably decompressed by the remote processing unit 14 using a decompression algorithm.

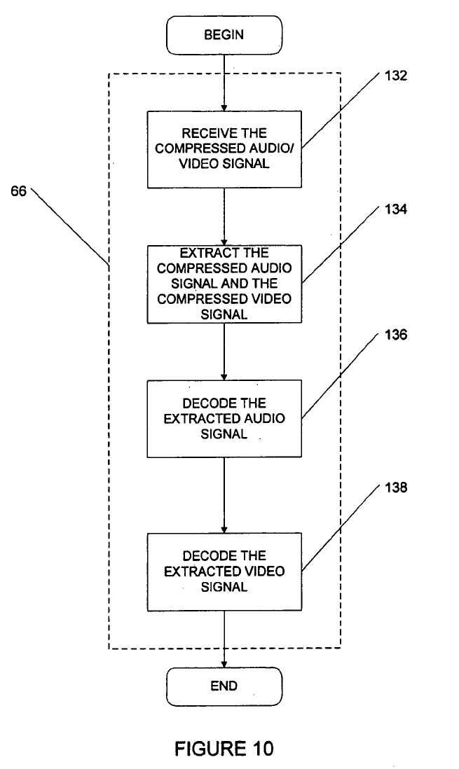

Now referring to FIG. 10, there is shown a flowchart which discloses the decompression algorithm. According to step 132, a compressed audio/video signal is received.

According to step 134, a compressed audio signal and a compressed video signal are extracted from the compressed audio/video signal. According to step 136, the extracted audio signal is decoded. According to step 138, the extracted video signal is decoded. It should be appreciated that steps 136 and 138 are preferably performed in parallel. Furthermore, it should be understood that steps 136 and 138 respectively perform the converse step of the transformations performed in steps 110 and 118 of FIG. 9.

It will be appreciated that the decompression algorithm may be implemented using hardware or software. In a preferred embodiment, the decompression algorithm is implemented in software.

Now referring back to FIG. 5 and according to step 68, the decompressed signal is provided on the remote user interface.

Now referring back to FIG. 2, in the case where the selected remote user is not logged on the audio/video server unit 16 and according to step 30, a test is performed in order to find out if the remote user is authorized to leave a message on the answering machine. The test is preferably performed using the audio/video server unit 16 and the user database 18. It will be appreciated that the answering machine may be at least one of a voice answering machine, a video answering machine, a text message answering machine or the like.

In the case where the remote user is not authorized to leave a message on the answering machine and according to step 40, a message is displayed on the user interface of the first processing unit 10. In fact, a message to request access to communicate with the remote user is provided by the first processing unit 10 to the remote processing unit 14.

In the case where the remote user has authorized the user to leave a message on its answering machine and according to step 36, an answering machine message is provided to the user interface of the first processing unit 10. The answering machine may be at least one of an audio answering machine message, a video answering machine message, a text message or the like.

In response to the answering machine message displayed on the user interface of the first processing unit 10, a response may be provided according to step 38 to the remote user.

It will be appreciated that the response may be at least one of an audio response message, a video response message, a text message or the like. It should be further understood that the response is provided to audio/video server unit 16 which preferably stores it in the user database 18.

Alternatively, the response message may be retrieved from the server and provided to the remote user using other means such as email for instance and/or voice message to any communication device, PDA, etc. It will be appreciated that the response message may be retrieved from the remote user using a connection to the server unit 16. In the case of an email, the latter may be provided to the user via any communication device.

Still referring to FIG. 2, in the case where the user is not known and according to step 24, an account is created for the user. Preferably the account is created via the user interface of the first processing unit 10.

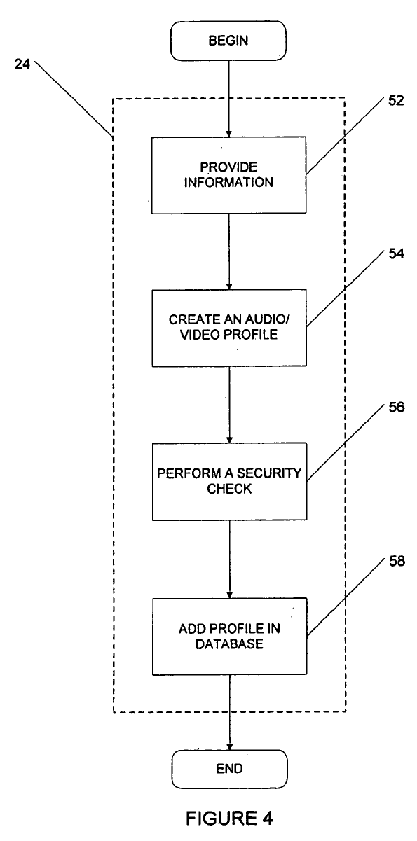

Now referring to FIG. 4, there is shown how the account is created. According to step 52, subscribing information is provided by the user. The subscribing information is provided to the audio/video server unit 16 by the user via the first processing unit 10.

The subscribing information comprises at least one information selected from the group consisting of the first name of the user, the last name of the user, the address of the user, the phone number of the user, the IP address, non-sensible personal data for identification of the user such as photo, mother name, birth data, social security number of the user or the like.

In a preferred embodiment, the subscribing information is encrypted prior to being sent to the audio/video server unit 16. In a preferred embodiment of the invention, secure socket layer is used to encrypt the information. At least one part of the provided subscribing information is stored in the user database 18 of the audio/video server unit 16.

According to step 54, an audio/video profile is created by the user via the user interface of the first processing unit 10. The audio/video profile comprises information such as login, an audio/video greeting message.

According to step 56, a security check is performed on the first processing unit 10. It will be appreciated that such security check is performed in order to avoid abusive use of the system. The security check comprises capturing the IP address of the first processing unit 10, capturing date and time, capturing a serial number of the processor of the first processing unit. Such information is stored in the user database 18 by the audio/video server unit 16 and may be used in the future. However it should be understood that such step is not mandatory for practicing the invention.

According to step 58, a profile corresponding to the user of the first processing unit is created by the audio/video server unit 16 using the information provided at steps 52, 54 and 56. At this point the user may use his created profile to access the system via the first processing unit 10. It will be further appreciated that the user may add new contacts.

While it has been disclosed an embodiment of the first processing unit 10 and the remote processing unit 14, it should be understood that these may be a dedicated hardware processing unit having for instance a touch screen or a translucent touch screen display device for displaying the user interface. The dedicated hardware processing unit may further comprise an internet web cam, a wired or wireless microphone, a wired or wireless network access and wired/wireless headsets. Those skilled in the art will appreciate that such dedicated hardware processing unit may therefore provide an integrated solution for videoconferencing which is compatible with the apparatus disclosed herein.

The embodiments of the invention described above are intended to be exemplary only. The scope of the invention is therefore intended to be limited solely by the scope of the appended claims.

1. A method for providing a platform-independent audio/video service, said method comprising:
providing an audio/video signal for transmission;
encapsulating said audio/video signal into a data packet, said data packet to be read using a sequence of processing operations suitable for viewing an audio/video signal;
delivering said encapsulated audio/video signal; and
wherein said sequence of processing operations is independent of a given type of processing unit and thereby enables the provision of a platform-independent audio/video service.

2. The method as claimed in claim 1, wherein said sequence of processing operations is compiled and is comprised in a software application.

3. The method as claimed in claim 2, wherein said providing an audio/video signal comprises providing a list of a plurality of users and selecting a given user from said provided list.

4. The method as claimed in claim 2, wherein said software comprises a Web browser.

5. The method as claimed in claim 4, wherein said providing an audio/video signal comprises providing a list of a plurality of users and selecting a given user from said provided list.

6. The method as claimed in claim 5, wherein said providing said list further comprises obtaining said list of a plurality of users from an audio/video server.

7. The method as claimed in claim 6, further comprising connecting to said audio/video server via a Web browser, further wherein said providing said list is performed in response to said connecting.

8. The method as claimed in claim 7, wherein said connecting to said audio/video server comprises providing a login and password for performing an authentication.

9. The method as claimed in claim 8, wherein providing said list of a plurality of users is performed according to said authentication.

10. The method as claimed in claim 1, wherein said sequence of processing operations is implemented in a chip.

11. The method as claimed in claim 1, wherein said encapsulating further comprises compressing the audio/video signal according to a compression protocol, and further wherein said delivering of said encapsulated audio/video signal further comprises decompressing said encapsulated audio/video signal according to said protocol.

12. The method as claimed in claim 11, wherein said encapsulating comprises evaluating the availability of audio/video resources for providing said audio/video signal and performing a packet split, an encapsulation and an encoding of said audio signal and a packet split, an encapsulation and an encoding of said video signal according to said availability.

13. The method as claimed in claim 1, wherein said audio/video signal to be transmitted to a given user further comprises a text message.

14. The method as claimed in claim 1, further comprising delivering said encapsulated audio/video signal to a group of users from said plurality of users.

15. The method as claimed in claim 1, wherein said delivering to said user comprises detecting if said user is logged on and further wherein said delivering comprises providing said encapsulated audio/video signal to said user if said user is logged on.

16. The method as claimed in claim 15, wherein said delivering further comprises checking if it is possible to leave an audio/video message to said user if said user is not logged on or if another audio/video signal is being delivered from another user.

17. The method as claimed in claim 16, wherein said delivering further comprises leaving an audio/video message to said user.

18. The method as claimed in claim 17, wherein said welcome message comprises at least one of a video message, an audio message and a text message.

19. The method as claimed in claim 17, further comprising providing an answering machine absence message and wherein said providing of said audio/video message to said user is performed in response to said providing said answering machine absence message.

20. The method as claimed in claim 19, wherein said answering machine absence message comprises at least one of a video message, an audio message and a text message.

21. The method as claimed in claim 1, wherein said delivering further comprises checking if said user is a registered user and providing a message to said user for inviting said user to perform a registration if said user is not registered.

22. The method as claimed in claim 15, wherein said delivering comprises providing an alert to said user if said user is logged on.

23. The method as claimed in claim 22, further comprising providing said encapsulated audio/video signal to said user if said user responds to said alert.

24. The method as claimed in claim 1, wherein said sequence of processing operations is comprised in a Flash player for displaying said audio/video signal.

25. A method for providing a platform-independent audio/video service to a user using a processing unit connected to a network, said method comprising:
said user performing a registration check for said service;
providing an audio/video signal from an audio/video source;
producing an audio/video output from said audio/video signal using a sequence of processing operations that is independent of operating systems running said user's processing unit; and
displaying said audio/video output to said user.

26. The method as claimed in claim 25, wherein said providing an audio/video signal further comprises compressing the audio/video signal according to a compression protocol, and further wherein said producing audio/video outputs further comprises decompressing said encapsulated audio/video signal according to said protocol.

27. The method as claimed in claim 26, wherein said encapsulating comprises evaluating the availability of audio/video resources for providing said audio/video signal and performing a packet split, an encapsulation and an encoding of said audio signal and a packet split, an encapsulation and an encoding of said video signal according to said availability.

28. The method as claimed in claim 26, further comprising loading said compression protocol into each user's processing unit.

29. The method as claimed in claim 25, further comprising delivering said audio/video signal from at least one user to another user.

30. The method as claimed in claim 28, further comprising encapsulating said audio/video signal into a data packet prior to said delivery.

31. The method as claimed in claim 25, further comprising storing said audio/video output into an audio/video message.

32. The method as claimed in claim 30, further comprising alerting a user that an audio/video message is stored.

33. The method as claimed in claim 25, further comprising loading said sequence of processing operations into each user's processing unit.

34. The method as claimed in claim 25, further comprising paying a fee for at least one of accessing said web site and displaying said audio/video outputs.

35. The method as claimed in claim 25, wherein said displaying further comprises displaying advertisement.

36. The method as claimed in claim 35, further comprising paying a fee for displaying said advertisement.

37. The method as claimed in claim 25, wherein said audio/video signal to be transmitted to a given user further comprises a text message.

38. The method as claimed in claim 25, wherein said user comprises a set of users from plurality of users, thereby providing said audio/video service to said set of users.

39. The method as claimed in claim 38, wherein said providing an audio/video signal from an audio/video source comprising providing a plurality of audio video/signals from a corresponding plurality of audio/video sources.

40. The method as claimed in claim 25, wherein said performing a registration check comprises accessing a web site.

41. The method as claimed in claim 25, wherein said sequence of processing operations is comprised in a Flash player for displaying said audio/video output.

42. A method for providing a platform-independent audio/video service to a plurality of users, said method comprising:
providing an audio/video signal to be transmitted to a user from at least one of said plurality of users;
encapsulating said audio/video signal into a data packet, said data packet to be read by a web browser comprising a module for delivering a video signal;
delivering said encapsulated audio/video signal to said user via said web browser; and
wherein said module is comprised in said web browser by default.

43. A method for providing a platform-independent audio/video service to a user using a processing unit connected to a network, said method comprising:
said user accessing a web site to perform a registration check for said service;
providing an audio/video signal from an audio/video source;
producing an audio/video output from said audio/video signal using a web browser comprising a module for delivering a video signal; and
displaying said audio/video output to said user through said web browser.

44. The method as claimed in claim 43, wherein said web browser comprises a Flash player for displaying said audio/video output.
